(19) United States
(12) Patent Application Publication
(10) Pub. No.: US 2005/0180397 A1
(43) Pub. Date: Aug. 18, 2005

(54) Call processing system and method in a voice and data integrated switching system

(76) Inventor: Eung-Moon Yeom, Suwon-si (KR)

Correspondence Address: Robert E. Bushnell, Suite 300, 1522 K Street, N.W., Washington, DC, 20005-1202, US

(21) Appl. No.: 11/013,852

(22) Filed: Dec. 17, 2004

(30) Foreign Application Priority Data
Feb. 3, 2004 (KR) 2004-7061

(51) Int. Cl. H04L 12/66

(52) U.S. Cl. 370/352

(57) ABSTRACT

A voice and data switching system that integrates a router/data switching module into a voice PBX to realize a voice and data integrated switch thereby providing an IP-based voice and data service platform which can be easily installed and unified in operation and maintenance. Further, the voice and data switching system of the invention can also provide legacy voice terminal or PSTN interface modules link as well as allow average user PCs to be linked with various servers. The system utilizes a VoIP transcoding technique, CoS and QoS functions of a router into the voice and data integrated switching system.

### CLAIM OF PRIORITY

This application makes reference to, incorporates the same herein, and claims all benefits accruing under 35 U.S.C. §119 from an application for APPARATUS AND METHOD PROCESSING CALL IN VOICE/DATA INTEGRATION SWITCHING SYSTEM earlier filed in the Korean Intellectual Property Office on 3 Feb. 2004 and there duly assigned Serial No. 2004-7061.

### BACKGROUND OF THE INVENTION

1. Field of the Invention

The present invention relates to a call processing system and method in a voice and data integrated switching system having a data switch module and a router integrated into a private branch exchange, more particularly, for setting subscriber priority and processing calls according to the priority such as CoS and QoS.

2. Description of the Related Art

The Internet protocol (IP) network is constantly in performance and service through the rapid spread of Internet growth and the demand for various services associated therewith. As a result, more various services are steadily required in the market.

As one of the requirements, voice transmission via the IP network is placed as one of the major functions of the IP network as is data transmission, which also require various voice transmission techniques associated therewith. Therefore, there are needs for the integration between conventional terminal communication using digital telephones, single telephones and so on and Voice over IP (VoIP) communication.

Accordingly, terminals available on the IP network are necessarily designed to have the same shape and operation as those of conventional digital telephones so as to respond to various requirements. Internet-phones (IP-phones) are developed as a result of such requirements.

In general, the IP-phones communicate with a switching system via the ITU-T recommended H.323 protocol. The H.323 protocol is for multimedia communication such as voice, image and data.

In addition, an IP based voice communication system includes a voice PBX. Conventional voice PBX systems are generally realized in the form of standalone, built-in and server type systems without routing functions, and thus heavily restricted in processing the Quality of Service (QoS) and Class of Service (CoS) of the VoIP communication. However the conventional voice PBX systems having QoS functions based upon codec, multi-frame count, silence suppression, jitter optimization factor and echo cancellation confront a problem that only limited QoS can be processed at the terminal end of the voice PBX system.

Further, there is another problem in that queuing and Bandwidth on Demand (BoD) techniques are not easily adopted in QoS and CoS techniques of the VoIP communication because a router, a VoIP system and a legacy voice system are provided as separate units.

### SUMMARY OF THE INVENTION

It is an object of the invention to provide a voice and data integrated switching system having a router, a data switch and a voice PBX integrated into one unit to facilitate installation and enable unified operation and maintenance, by which conventional voice terminals and PSTN interface modules can be used, and conventional voice calling together with voice calling and various multimedia data services via the Internet can be realized with a single equipment.

It is another object of the invention to provide a call processing system and method in the voice and data integrated switching system which can utilize various database techniques of legacy key phone systems to classify subscriber VoIP CoS based upon Caller ID (Tel No IP) and Called IP (Tel No IP) so that a router module process CoS services based upon the classified policy.

According to an aspect of the invention for realizing the above objects, there is provided a voice and data integrated switching system linked to at least one network, wherein the switching system may comprise a voice and data integrated processing module for format-converting an input voice signal via a first network and an input voice data packet from second and third networks into a voice data packet and a voice signal, respectively, to transmit the voice data packet and the voice signal to the second and first networks, respectively, switching the voice data packet to the second network and the voice signal to the first network, and routing the switched voice packet through a corresponding network according to set routing information.

Preferably, the first network includes a PSTN, the input voice signal via the first network is a PCM coded voice signal, the second network includes an IP network linked via at least one interface selected from the group consisting of a LAN, WAN, xDSL and cable modem, and the input voice data packet via the second network is a VoIP packet.

According to an aspect of the voice and data integrated switching system linked to at least one network, the voice and data integrated processing module may comprise: a voice converting section for compressing an input PCM coded voice signal via the first network into a voice data packet and converting an input voice packet via a network into a PCM coded voice signal before outputting the same; a control section for switching and routing the compressed voice data packet from the voice converting section according to set routing information and providing an input voice data packet via the second network into the voice converting section; and a switching section for switching the input voice data packet via the second network to the control section and switching the routed voice data packet from the control section to a corresponding network interface.

The voice and data integrated processing module may further comprise at least one interface for interfacing the routed voice data packet from the control section via a WAN serial port, an xDSL modem, a cable modem and a DMZ port to the IP network, and interfacing the routed voice data packet to the switching section.

The voice and data integrated processing module may further comprise at least one Ethernet interface for interfacing the switched voice data packet from the switching section to a corresponding terminal based upon corresponding IP address information, and interfacing an input voice data packet from the terminal via the switching section to the control section.

The voice and data integrated processing module may further comprise an uplink interface for interfacing the switched voice data packet from the switching section to an upper link, and an input voice data packet via the upper link to the switching section.

The voice and data integrated processing module may further comprise a dual port memory for temporarily storing signaling messages so that the control section processes the signaling messages for caller and called IP call processing; and a memory for storing routing information, subscriber information and programs for the execution of the control section.

The voice and data integrated processing module may further comprise a securing processor connected via a PCI bus to the control section to execute a hardware-based tunneling function via data encryption, decryption and authentication required for the establishment of an imaginary private LAN.

According to another aspect of the voice and data integrated switching system linked to at least one network, the voice and data integrated processing module may comprise: a voice converting section for compressing an input PCM coded voice signal via the first network into a voice data packet and converting an input voice packet via a network into a PCM coded voice signal before outputting the same to a first network; a control section for switching and routing the compressed voice data packet from the voice converting section according to set routing information and providing an input voice data packet via the second network into the voice converting section; and a switching section for switching the input voice data packet via the second network to the control section and switching the routed voice data packet from the control section to a corresponding network interface, wherein the voice converting section, the control section and the switching section are integrated into a single module.

According to further another aspect of the invention for realizing the above objects, there is provided a voice and data integrated switching system comprising: a priority setting section for setting class information for priority call processing according to subscribers; a voice data converting section for converting an input voice signal from a subscriber terminal into a voice data packet via compression according to the class information set in the priority setting section; and a routing section for routing the converted voice data packet from the voice data converting section to an IP address of a destination terminal.

Preferably, the call processing class information set by the priority setting section is classified according to call types including local and long distance calls, and the class information set by the priority setting section contains at least one selected from a group consisting of the telephone number of called and caller terminals according to subscribers, IP information, voice data conversion card selection information and voice data conversion card output port information.

Preferably, the priority setting section, upon receiving a signaling message for call processing based upon the class information set for the call processing priority according to subscribers, analyzes a header information of the received signaling message to confirm the class of a corresponding subscriber, and allocates a corresponding one of at least one voice data packet conversion card in the voice data converting section and an output port of the corresponding voice data packet conversion card based upon the confirmed class information.

Preferably, the voice data conversion section converts the voice signal from the subscriber terminal into the voice data packet by using the voice data conversion card allocated in the priority setting section, and outputting the converted voice data packet via the allocated output port to the routing section.

Preferably, the priority setting section, after setting the class information for the priority call processing according to subscribers, sets Quality of Service (QoS) information for the priority routing of the voice data packet in the routing section according to IP information of the set class information.

Preferably, the QoS information set in the routing section includes at least one selected from a group consisting of caller and called terminal IP information and output port information, the IP information of the QoS information set in the routing section includes at least one of a group consisting of priority, available bandwidth for voice data packet transmission and maximum bandwidth information allocatable in the absence of available bandwidth, and the bandwidth is differentially set according to the class by calculating an entire bandwidth according to the number of users of the corresponding class and the number of entire VoIP calls.

According to other aspect of the invention for realizing the above objects, there is provided a call processing method in a voice and data integrated switching system, the method comprising the following steps of: setting class information for priority call processing according to subscribers; converting an input voice signal from a subscriber terminal into a voice data packet according to a compression type set for a corresponding subscriber; and analyzing the voice data packet converted according to the set class information to route the voice data packet to an IP address of a destination terminal.

Preferably, the class information setting step comprises: upon receiving a call processing signaling message according to the call processing priority class information according to subscribers, analyzing the header information of the received message to confirm the class information of a corresponding subscriber and allocating a corresponding one of the voice data packet conversion cards and an output port of the corresponding conversion card according to the confirmed class information.

Preferably, the step of converting an input voice signal into a voice data packet comprises: converting the input voice signal from the subscriber terminal into the voice data packet with an allocated voice data conversion card and outputting the converted voice data packet via an allocated output port.

Preferably, the step of setting class information comprises: setting the class information for priority call processing according to subscribers and setting Quality of Service (QoS) information for priority routing of the converted voice data packet according to IP information of the set class information.

According to yet another aspect of the invention for realizing the above objects, there is provided a class setting method for priority call processing in a voice and date integrated switching system, the method comprising the following steps of: setting class information for priority call processing based upon caller and called terminal information according to subscribers; allocating voice conversion card information for voice data packet conversion of an input voice signal based upon the priority call processing class information according to subscribers; and setting Quality of Service (QoS) information for priority routing of the converted voice data packet according to IP information of the set class information.

### BRIEF DESCRIPTION OF THE DRAWINGS

A more complete appreciation of the invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram illustrating a voice PBX connected with an Ethernet switch;

FIG. 2 is a block diagram illustrating a voice and data integrated switching system according to the principles of the present invention;

FIG. 3 is a block diagram illustrating a voice and data processing module in the voice and data integrated switching system in FIG. 2;

FIG. 4 is a block diagram illustrating a call processing unit in the voice and data integrated switching system of the invention;

FIG. 5 is a flow chart illustrating a priority setting process of the call processing method in the voice and data integrated switching system of the invention; and

FIG. 6 is a flow chart illustrating the call processing method according to the priority set in FIG. 5.

### DETAILED DESCRIPTION OF THE PREFERRED EMBODIMENTS

Preferred embodiments of a call processing system and method in a voice and data integrated switching system of the invention will be described in detail with reference to the accompanying drawings.

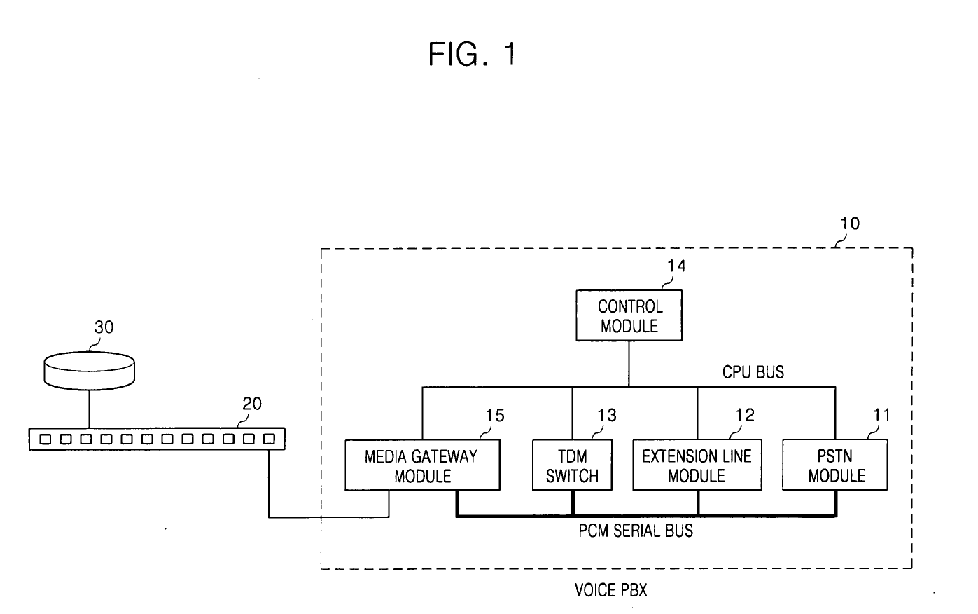

FIG. 1 is a conceptual view illustrating a voice PBX connected with an Ethernet switch in an IP based voice communication system.

As shown in FIG. 1, an IP based voice communication system includes a voice PBX 10, a data switch 20 and a router 30.

The voice PBX 10 converts voice data into packet data, and the switch 20 switches the packet data to the router 30. Available examples of the data switch 20 include an Ethernet switch.

The voice packet data switched by the data switch 20 is transmitted by the router 30 to the Internet.

The voice PBX 10 includes a Public Switched Telephone Network (PSTN) module 11 for matching with a PSTN, an extension line module 12 for matching with extension subscriber terminals, a Time Division Multiplexing (TDM) switch module 13 for dividing a plurality of voice signals according to respective time periods (e.g., time slots), a media gateway module 15 for converting the voice signals transmitted from the TDM switch module 13 into voice data packets and converting voice data packets transmitted from the data switch 20 into PCM-coded voice signals or PCM voice signals and a control module 14 for controlling the afore-described modules.

The media gateway module 15, the TDM switch module 13, the extension line module 12 and the PSTN module 11 are connected with one another via PCM serial buses, respectively, and the control module 14 is connected with the modules 11, 12, 13 and 15 via CPU buses, respectively. In brief, the media gateway module 15 in the voice PBX 10 compresses PCM-converted voice signals into voice packets and transmits the voice packets to the data switch 20, and restores voice packets from the data switch 20 into PCM voice signals.

As shown in FIG. 1, the voice PBX 10, the external data switch 20, the additional media gateway module 15 for allowing the former to cooperate with each other and the router 30 for allowing the link to the PSTN to execute IP based voice communication services is needed. As a consequence, the data switch 20, the router 30 and the voice PBX 10 are provided as separate equipments and thus disadvantageous in the aspect of system operation and maintenance.

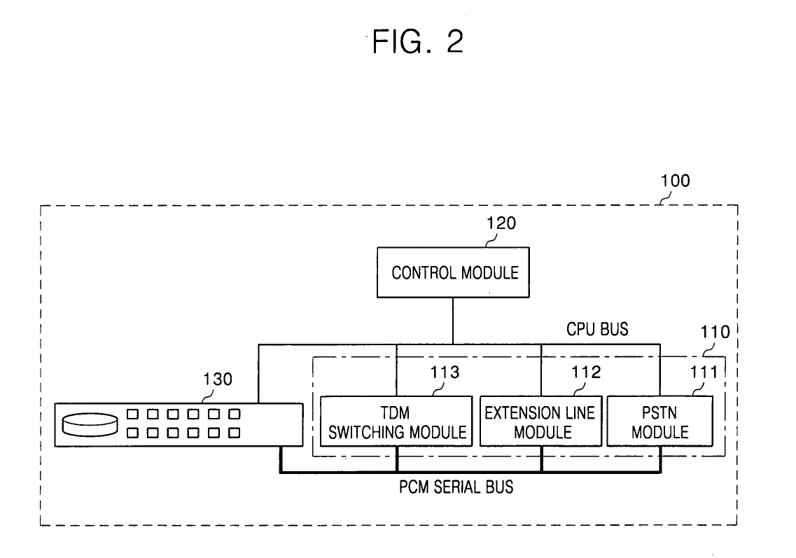

FIG. 2 is a block diagram illustrating a voice and data integrated switching system according to the principles of the present invention.

As shown in FIG. 2, the voice and data integrated switching system of the invention includes subscriber trunk card 110 consisting of a PSTN module 111, an extension line module 112 and a TDM switching module 113, a control module 120 and a voice and data processing module 130, in which the parts similar to those shown in FIG. 1 will not be further described.

The voice and data integrated switching system 100 is provided with the voice and data processing module 130 by integrating the router, the data switching module and the media gateway module in a voice PBX into one module, which are separate modules in FIG. 1.

That is, the invention as shown in FIG. 2 provides the router and the data switch within the voice PBX unlike as shown in FIG. 1, in which the data switch and router are provided outside the voice PBX, so that a single module can execute a voice compression codec function which is performed in a media gateway module.

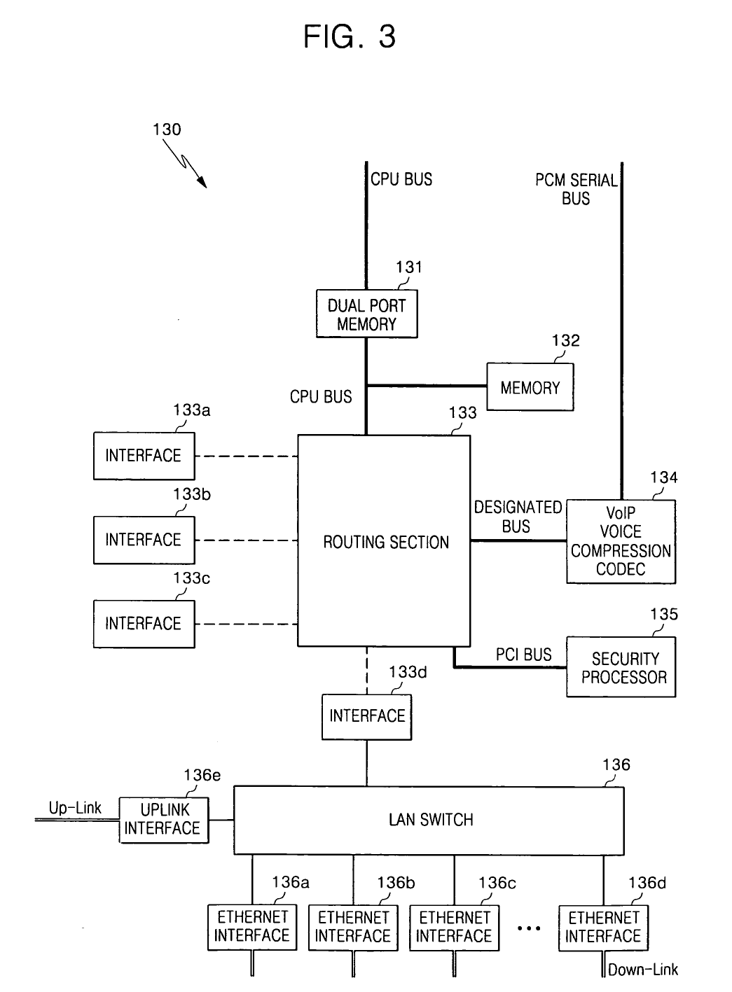

The constitution and operation of the voice and data processing module 130 having the router, the data switch and the media gateway modules integrated into one unit will now be described in detail with reference to FIG. 3.

FIG. 3 is a block diagram illustrating a voice and data processing module in the voice and data integrated switching system in FIG. 2;

As shown in FIG. 3, the voice and data processing module 130 includes a dual port memory 131, a memory 132, a routing section 133, a VoIP voice compression codec 134, a security processor 135, a LAN switch 136 and various interfaces 133a˜133d and 136a˜136e.

The dual port memory 131 stores signaling messages via a first port from the control module 120 shown in FIG. 2 so that the routing section 133 can read the stored signaling messages from the dual port memory 131 via a second port.

The memory 132 includes a RAM and a flash memory, and stores various data including programs necessary for the operation of the routing section 133, routing information and subscriber information.

The routing section 133 transmits a voice data packet via interfaces 133a to 133c to the Internet and via the interface 133d to the LAN switch 136 so that the voice data packet can be sent to an IP network.

Upon receiving the voice data packet via the interfaces 133a to 133d, the routing section 133 provides the voice data packet to the VoIP voice compression codec 134. As a result, the routing section 133 controls the routing and switching of the voice data packet.

The routing section 133 is connected to the interfaces 133a to 133d, in which the interface 133a includes a V.35 transceiver to transmit/receive a data packet via a WAN serial port, and the interfaces 133b and 133c transmit/receive a data packet via an xDSL or cable modem.

The interface 133d provides a data packet channel to the LAN switch 136, and as not shown in the drawings, may include a DMZ interface for the link to a web page server or an e-mail server.

The VoIP voice compression codec 134 converts a PCM-coded voice signal from the TDM switching module in FIG. 2 into an IP voice data packet, and compresses the IP voice data packet to be transmitted via the routing section 133 to the IP network. The VoIP voice compression codec 134 also converts a voice data packet received via the IP network into a PCM voice signal and provides the PCM voice signal via a PCM serial bus to the TDM switching module 113 shown in FIG.2.

The security processor 135 is connected to the routing section 133 via a PCI bus to realize a hardware based tunneling function via data encryption, decryption and authentication that are needed for the establishment of an imaginary private LAN. That is, the voice and data packet to be transmitted/received is encrypted or decrypted via capsulation/de-capsulation thereby to establish the imaginary private LAN.

The LAN switch 136 receives a voice data packet from the routing section 133 via the interface 133d, and transmits the voice data packet to a called or destination terminal via any of the interfaces 136a to 136d corresponding to the destination terminal, in which examples of the interfaces 136a to 136d may include an Ethernet interface, and examples of the terminals connected to the interfaces 136a to 136d may include a PC, IP phone and so on.

Further, the LAN switch 136 receives a voice and data packet from terminals via the interfaces 136a to 136d, and provides the voice and data packet to the routing section 133 via the interface 133d. Therefore, the routing section 133 provides the received voice and data packet to the VoIP voice compression codec 134.

The LAN switch 136 is connected with an uplink interface 136e which can transmit/receive a voice and data packet via an uplink (e.g., at a ratio of 100M/1 G).

The operation of the voice and data integrated switching system of the invention having the afore-described constitution will be described as follows.

First, a signaling message about an input IP voice call is provided via the LAN switch 136 to the routing section 133, which in turn converts the signaling message about an input IP call into a voice call processing message and provides the converted voice call processing message via the dual port memory 131 to the control module 120 shown in FIG. 2.

A signaling message for outgoing IP voice call processing is provided to the routing section 133 via the dual port memory 131 from the control module 120, shown in FIG. 2, and the routing section 133 converts the signaling message for the processing of an outgoing IP voice call into IP message packets and transmits the IP message packets via the LAN switch 136 to a terminal connected to the IP network.

In the meantime, an IP voice packet introduced via the interfaces 136a to 136d is provided via the LAN switch 136 to the routing section 133, and an IP voice data packet introduced to the interfaces 133a to 133d via the WAN, xDSL or cable modem is also provided to the routing section 133.

The routing section 133 provides the IP voice data packet via a designated bus to the VoIP voice compression codec 134.

The VoIP voice compression codec 134 converts the IP voice data packet from the routing section 133 into a PCM coded voice signal and provides the PCM coded voice signal via the PCM serial bus to the TDM switching module 113 as shown in FIG. 2.

On the contrary, the VoIP voice compression codec 134 converts a PCM coded voice signal which is transmitted via the PCM serial bus from the TDM switching module 113, as shown in FIG. 2, into an IP voice packet and provides the IP voice packet via a designated bus to the routing section 133.

The routing section 133 provides the IP voice packet from the VoIP voice compression codec 134 to the LAN switch 136, which in turn transmits the IP voice packet from the routing section 133 via the interfaces 136a to 136d to the IP network and thus to the address of a corresponding terminal.

In the meantime, an IP packet introduced via the interfaces 133a to 133c as shown in FIG. 3 such as the WAN serial port, xDSL modem and cable modem is provided via the interfaces 133a to 133c to the routing section 133.

Therefore, the routing section 133 re-transmits the IP packet via the interfaces 133a to 133c such as the WAN serial port, xDSL modem and cable modem to the outside (Internet) according to a corresponding IP address, or via the LAN switch 136 to a corresponding terminal.

Further, the security processor 136 connected to the routing section 133 via the PCI bus realizes a hardware based tunneling function via data encryption, decryption and authentication that are needed for the constitution of an imaginary private LAN to prevent any performance degradation of the whole module.

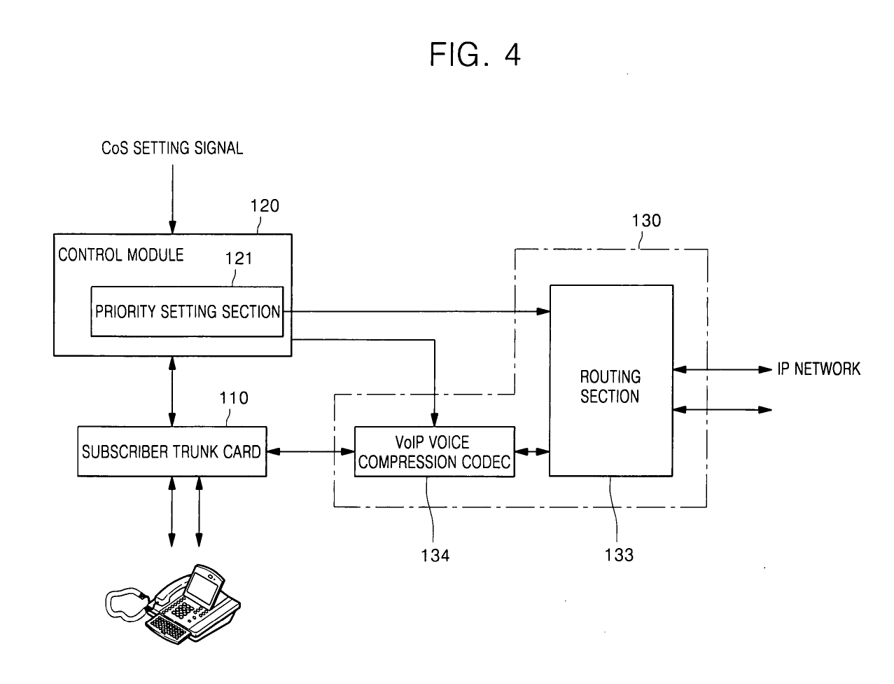

Now a call processing operation in the voice and data integrated switching system of the invention will be described with reference to FIG. 4.

FIG. 4 is a block diagram illustrating a call processing unit in the voice and data integrated switching system of the invention, in which the parts that are the same as those shown in FIG. 3 are designated with the same reference numerals, and those described with reference to FIG. 3 will not be further described.

In FIG. 4, the VoIP voice compression codec 134 includes at least one conversion card or transcoding card which compresses voice data packets according to different techniques. Available examples of the transcoding card may include a G.723.1 card, G.729 card and G.729A card.

At the input of a Class of Service (CoS) setting signal for allowing an operator to determine packet priority, a priority setting section 121 sets CoS information for subscriber priority according to the input CoS setting signal and sets subscriber's Quality of Service (QoS) information according to the CoS information in the routing section 133 of the voice and data processing module 130. The CoS information set by the priority setting section 121 may include caller ID, called ID and subscriber's transcoding card information (for example card ID and output port information of a corresponding card), and the caller and called IDs may include the telephone number and IP address information of the caller and called.

Examples of the QoS information set in the routing section 133 may include caller and called IP address information, output port information and so on.

Also, voice data packets received via the subscriber trunk card 110 are compressed by corresponding transcoding cards of the VoIP voice compression codec 134, and then transmitted by the routing section 133 to the IP network according to the priority of the QoS information.

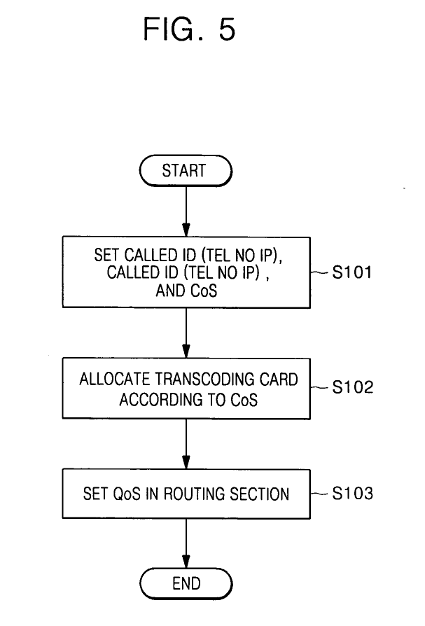

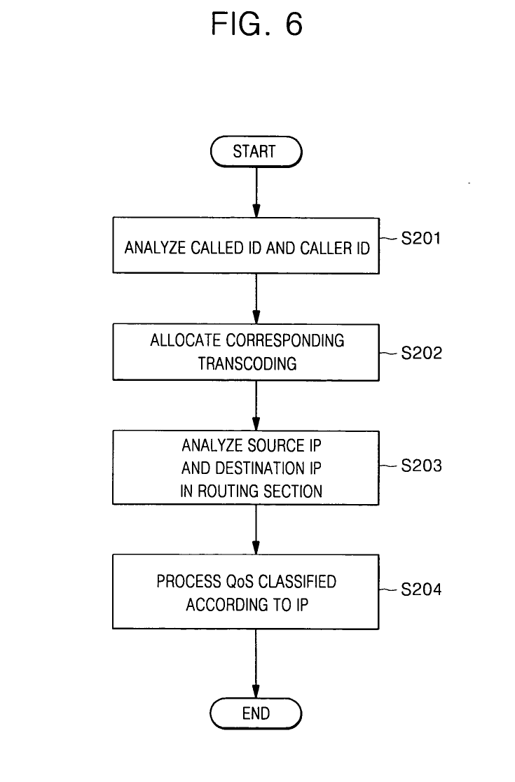

Hereinafter a call processing method in the voice and data integrated switching system of the invention using the call processing system of the afore-described constitution will be described stepwise with reference to accompanying FIGS. 5 and 6.

FIG. 5 is a flow chart illustrating a priority setting process of the call processing method in the voice and data integrated switching system of the invention, and FIG. 6 is a flow chart illustrating the call processing method according to the priority set in FIG. 5.

For the purpose of priority packet processing according to the invention, there is required a process for setting CoS and QoS according to subscribers as illustrated in FIG. 5.

As shown in FIG. 5, the CoS and QoS setting process may be divided into a CoS setting step S101 in which the priority setting section 121 of the control module 120 shown in FIG. 4 classifies and sets CoS according to callers, a card allocation step S102 for allocating VoIP transcoding cards according to the CoS set in S101 and a QoS setting step S103 for setting QoS according to the allocated transcoding cards.

This process will now be described in more detail.

First, the step S101 classifies and sets a database in the priority setting section 121 according to the CoS policy that is defined by the control module 120 shown in FIG. 4 according to caller or called telephone number and called terminal IP (i.e., CoS definition according to local call and long distance call by the caller).

The step S102 shown in FIG. 5 classifies or allocates VoIP trasnscoding cards in the VoIP voice compression codec 134 according to the CoS defined in S101 above, in which the VoIP transcoding cards are to be allocated in VoIP call processing.

The VoIP transcoding card classification according to the CoS defined in S101 is executed for the same reason as the QoS is processed according to IPs in the routing section 133 to set the caller transcoding card IP of the VoIP voice call processing according to the CoS defined in S101.

Further, the CoS may be defined according to a called IP. That is, the control module 120 can acquire IP address information according to a caller telephone number by using a VoIP call processing IP table, that is, an IP table in which a remote terminal IP address can be found with reference to telephone number information to process a VoIP call. Then, the acquired IP address can be set in the priority setting section 121 according to called user CoS.

Alternatively, the CoS may be set by discriminating local call, long distance call and so on according to caller telephone number information.

As a consequence, it is possible to set the transcoding card IP of the caller VoIP call and the remote VoIP terminal IP according to the call type such as local and long distance call or the called user in the priority setting section 121 of the control module 120 at VoIP call processing.

In the meantime, the step S103 sets the QoS in the routing section 133 according to the set the CoS after the completion of the CoS setting as above.

That is, the routing section 133 may set the QoS according to IPs, ports and so on, but will set the QoS according to EPs since the previous steps S101 and S102 set the CoS according to Ips.

As a consequence, the control module 120 and the routing section 133 as shown in FIG. 4 cooperate with each other so that the QoS according to subscribers can be automatically set in the routing section 133 based upon the CoS set in the priority setting section 121 of the control module 120.

The QoS setting step in the routing section 133 can set call processing priority, bandwidth, ceil and so on to realize differential QoS. That is, if a VoIP call is equally used in an external network (e.g., IP network) link interface, the priority and the available bandwidth may be set based upon the CoS according to IPs classified in S101 and S102 in the QoS setting by the routing section 133, and the ceil (i.e., maximum bandwidth allocatable if there is any reserved bandwidth) may be classified according to the CoS.

In the available bandwidth setting, the total bandwidth is calculated according to the user number of corresponding CoS and the total VoIP call number to perform differential setting of the CoS based bandwidth. (That is, the bandwidth is set by the differential application of the multiple calling rate according to CoS.) Therefore, the routing section 133 can process the QoS for calls according to the IP-classified CoS. In case of QoS processing other than the differential QoS processing, all VoIP packets can be equally priority-processed in the routing section 133.

A method of processing the differential QoS according to the VoIP and the CoS set as shown in FIG. 5 will be described stepwise with reference to FIG. 6.

As shown in FIG. 6, the control module 120 confirms the CoS of a VoIP service according to caller user information and called user information to process a VoIP call. That is, if a caller signaling message is received via the subscriber trunk card 110 as shown in FIG. 4, the control module 120 analyzes caller ID information and called ID information based upon the header information of the received caller signaling message in step S201.

The analyzed caller ID information and called ID information is compared with the CoS information set in the priority setting section 121 to obtain priority information, and transcoding cards are allocated in the VoIP voice compression codec 134 based upon the priority information in step S202. Herein, the transcoding cards are allocated based upon the priority information in order to compress voice data packets at different compression ratios according to the set priority. For example, a voice data packet of a high priority subscriber is allocated to a transcoding card of a high compression ratio in order to raise the transmission rate of the compressed voice data packet. Available examples of the transcoding card may include a G.723.1 card of 5.3 kpbs or 6.3 kbps and G.729 or G.729A cards of 8 kbps.

Further, the control module 120 provides corresponding information to the routing section 133 according to the priority information as analyzed above.

After the transcoding card allocation as above, a corresponding transcoding card in the VoIP voice compression codec 134 compresses a voice signal (e.g., a PCM coded signal) received via the subscriber trunk card 110 into a voice data packet (e.g., a VoIP packet) and stores the voice data packet in the routing section 133.

The routing section 133 analyzes the caller terminal IP and destination terminal IP by using the IP header of the VoIP packet from the corresponding transcoding card in the VoIP voice compression codec 134 in step S203.

As a consequence, the routing section 133 performs the QoS via a port set according to the caller and destination terminal IP information, as analyzed above, in step S204.

As set forth above, the call processing system and method in the voice and data integrated switching system of the invention integrates the router, the data switch and the voice PBX into one unit to facilitate installation and enable unified operation and maintenance, by which conventional voice terminals and PSTN interface modules can be used, and an IP voice calling service and various multimedia data services together with a conventional voice calling service can be realized with a single apparatus.

Further, in the voice and data integrated switching system, VoIP CoS is classified according to subscribers based upon Caller ID (Tel No IP) and Called ID (Tel No IP) by utilizing various database techniques of a legacy key phone system, and the QoS of a VoIP packet can be executed based upon the classified policy.

The above described embodiments of the invention are made for illustrative purposes only, but they are not to be construed as limitation to the scope of the invention. Therefore, it is to be understood that those skilled in the art can realize various forms of switching systems without departing from the scope of the invention. Since various changes and modifications according to the embodiments of the invention can be proposed by the those skilled in the art, the scope of right of the invention shall be defined by the appended claims.

As set forth above, the voice and data switching system of the invention integrates the router/data switching module into the voice PBX to realize the voice and data integrated switch thereby providing an IP-based voice and data service platform which can be easily installed and unified in operation and maintenance. Further, the voice and data switching system of the invention can also provide legacy voice terminal or PSTN interface modules link as well as allow average user PCs to be linked with various servers.

Moreover, the invention can integrate the key phone function of the legacy voice switching system, the VoIP transcoding technique and the QoS function of the router into the voice and data integrated switching system for SOHO (small office small home) Internet, which incorporates the legacy voice switching system, the VoIP system, the data switch and the router into one unit, in order to easily realize the QoS function that is restricted in the convention VoIP system.

1. A voice and data integrated switching system comprising:
a priority setting section for setting class information for priority call processing according to subscribers;
a voice data converting section for converting an input voice signal from a subscriber terminal into a voice data packet via compression according to the class information set in the priority setting section; and
a routing section for routing the converted voice data packet from the voice data converting section to an IP (Internet Protocol) address of a destination terminal.

2. The system according to claim 1, wherein the call processing class information set by the priority setting section is classified according to call types including local and long distance calls.

3. The system according to claim 1, wherein the class information set by the priority setting section contains at least one selected from a group consisting of the telephone number of called and caller terminals according to subscribers, IP information, voice data conversion card selection information and voice data conversion card output port information.

4. The system according to claim 1, wherein the priority setting section, upon receiving a signaling message for call processing based upon the class information set for the call processing priority according to subscribers, analyzes a header information of the received signaling message to confirm the class of a corresponding subscriber, and allocates a corresponding one of at least one voice data packet conversion card in the voice data converting section and an output port of the corresponding voice data packet conversion card based upon the confirmed class information.

5. The system according to claim 4, wherein the voice data conversion section converts the voice signal from the subscriber terminal into the voice data packet by using the voice data conversion card allocated in the priority setting section, and outputting the converted voice data packet via the allocated output port to the routing section.

6. The system according to claim 1, wherein the priority setting section, after setting the class information for the priority call processing according to subscribers, sets Quality of Service (QoS) information for the priority routing of the voice data packet in the routing section according to IP information of the set class information.

7. The system according to claim 6, wherein the QoS information set in the routing section includes at least one selected from a group consisting of caller and called terminal IP information and output port information.

8. The system according to claim 7, wherein the IP information of the QoS information set in the routing section includes at least one of a group consisting of priority, available bandwidth for voice data packet transmission and maximum bandwidth information allocatable in the absence of available bandwidth.

9. The system according to claim 8, wherein the bandwidth is differentially set according to the class by calculating an entire bandwidth according to the number of users of the corresponding class and number of entire VoIP (Voice over IP) calls.

10. A call processing method in a voice and data integrated switching system, the method comprising the steps of:
setting class information for priority call processing according to subscribers;
converting an input voice signal from a subscriber terminal into a voice data packet according to a compression type set for a corresponding subscriber; and
analyzing the voice data packet converted according to the set class information to route the voice data packet to an IP (Internet Protocol) address of a destination terminal.

11. The method according to claim 10, wherein the class information is classified according to call types including local call and long distance call.

12. The method according to claim 10, wherein the call processing class information includes at least one of a group consisting of telephone number information of caller and called terminals according to subscribers, IP information, voice data conversion card selection information and voice data conversion card output port information.

13. The method according to claim 10, wherein the class information setting step comprises: upon receiving a call processing signaling message according to the call processing priority class information according to subscribers, analyzing the header information of the received message to confirm the class information of a corresponding subscriber and allocating a corresponding one of the voice data packet conversion cards and an output port of the corresponding conversion card according to the confirmed class information.

14. The method according to claim 13, wherein the step of converting an input voice signal into a voice data packet comprises:
converting the input voice signal from the subscriber terminal into the voice data packet with an allocated voice data conversion card and outputting the converted voice data packet via an allocated output port.

15. The method according to claim 10, wherein the step of setting class information comprises:
setting the class information for priority call processing according to subscribers and setting Quality of Service (QoS) information for priority routing of the converted voice data packet according to IP information of the set class information.

16. The method according to claim 15, wherein the QoS information includes at least one of caller and called terminal IP information and output port information.

17. The call processing method according to claim 16, wherein the IP information includes at least one selected from a group consisting of priority, available bandwidth for voice data packet transmission and maximum bandwidth information allocatable in the absence of available bandwidth.

18. The method according to claim 17, wherein the bandwidth is differentially set according to the class by calculating an entire bandwidth according to the number of users of the corresponding class and number of entire VoIP (Voice over IP) calls.

19. A class setting method for priority call processing in a voice and date integrated switching system, the method comprising the steps of:
setting class information for priority call processing based upon caller and called terminal information according to subscribers;
allocating voice conversion card information for voice data packet conversion of an input voice signal based upon the priority call processing class information according to subscribers; and
setting Quality of Service (QoS) information for priority routing of the converted voice data packet according to IP (Internet Protocol) information of the set class information.

20. The method according to claim 19, wherein the class information is classified according to call types including local call and long distance call.

21. The method according to claim 19, wherein the call processing class information includes at least one of a group consisting of telephone number information of caller and called terminals according to subscribers, IP information, voice data conversion card selection information and voice data conversion card output port information.

22. The method according to claim 19, wherein the QoS information includes at least one of caller and called terminal IP information and output port information.

23. The method according to claim 22, wherein the IP information includes at least one selected from a group consisting of priority, available bandwidth for voice data packet transmission and maximum bandwidth information allocatable in the absence of available bandwidth.

24. The method according to claim 23, wherein the bandwidth is differentially set according to the class by calculating an entire bandwidth according to the number of users of the corresponding class and number of entire VoIP (Voice over IP) calls.
